(19) United States
(12) Patent Application Publication
(10) Pub. No.: US 2013/0167131 A1
(43) Pub. Date: Jun. 27, 2013

(54) Computer operating system install time predictor

(71) Applicant: Samuel L. Carson, San Diego, CA (US)

(72) Inventor: Samuel L. Carson, San Diego, CA (US)

(21) Appl. No.: 13/335,153

(22) Filed: Dec. 22, 2011

(51) Int. Cl. G06F 9/44

(52) U.S. Cl. 717/168

(57) ABSTRACT

A method and system for providing a reliable prediction of how long it will take to install or update an operating system on a computer. The method and system are based on the ability to obtain information on the hardware configuration of the computer and then use this information in conjunction with statistical modeling techniques to produce an estimate of how long it will take a computer's operating system to initially install or update.

### FIELD OF THE INVENTION

The present invention relates to computers and, more particularly, to the installation and updating of operating systems on computers.

### BACKGROUND OF THE INVENTION

All computers require the installation of an operating system. This is a job that is performed millions of times on new computers. On existing computers, operating systems often need to be reinstalled to correct problems or receive major updates to add new features. The person installing or updating an operating system would like to have an accurate prediction of how long it will take for the operating system to install so they can make appropriate plans and perform other tasks during that time. Current computer operating systems either provide a highly inaccurate prediction of the length of time the operating system will take to install or fail to provide any estimate at all. This contributes to the installer being unable to allocate time efficiently. This inability to obtain an accurate estimate of the time required to install a new operating system impacts information technology specialists and personal computer enthusiasts. The reason the problem exists is that the length of time required to install or update a computer's operating system is highly dependent upon the computer's particular hardware configuration.

There are a number of approaches currently in existence and common use that predict how long a computer program will take to install. These approaches effectively look at how long it took to install some fraction of a computer program and then extrapolate the length of time required to install the remaining portion of the program. Similar prediction approaches exist for how long it takes to download a file and are often part of installing a new program. Prediction approaches for file downloads operate on the same general principle, determining how long it takes to download some fraction of the file, or looking at the current download rate, and then making an extrapolation as to how long it will take to download the remainder of the file. These kinds of predictions are often updated frequently because of high variability in install or download conditions.

Current approaches for predicting how long it will take to install a computer program or download a file are inherently unreliable. This is because other programs that are running on the computer can influence how long it takes to install a new program since those other programs could be using relevant system resources. Likewise, existing methods for predicting how long it takes a file to download are highly dependent on the background internet speed along particular paths at the time the file is being downloaded. This dependence on these other processes inherently reduces the accuracy of timing predictions. In installing a new computer operating system or major update of an operating system, there are no other processes or applications running on the computer and installation takes place from some medium which is local to the computer. The hardware components of the computer now largely determine the length of the install time. Therefore, what is needed is a method for reliably predicting installation times for computer operating systems and major operating system updates that utilizes these unique features of the operating system installation environment.

### SUMMARY OF THE INVENTION

A method and system for reliably estimating the length of time likely to be required for the initial operating system installation on a computer or the installation of a major update to an operating system on a computer. The system and method are based on the ability to do repeated testing of operating system install times for one or more hardware configurations and then using this information to build a statistical predictive model(s) of install time length. This predictive model is then incorporated into an operating system installer. After detecting the computer's hardware, a predicted install time specific to that hardware configuration is produced. This predicted install time is displayed to the user and optionally revised at one or more points in the installation process.

The invention provides a reliable estimate of the amount of time it will take to install or update a computer operating system to someone performing such a task. Providing a reliable install time estimate will allow the operating system installer to be better informed and better able to plan other activities.

The invention makes use of the unique environment in which a new computer operating system or major update of an operating system occurs. With new operating system installations and major updates, unrelated processes are not present and installation occurs from a medium local to the computer. In this environment, the hardware configuration of the computer is the major determinant of how long the installation will take. In this environment, a statistical modeling framework can be used to produce reliable install time estimates.

An exemplary embodiment is a computer program product for providing a person with an estimate of the length of time that a computer operating system or major update to a computer operating system will take to install, including displaying the length of time left until predicted completion. The computer program product would utilize statistical information concerning the length of time an operating system takes to install on a particular set of hardware components that make up a computing system. The method determines the hardware components that are present and makes use of information gathered prior to the installation to statistically predict the length of time the initial operating system installation or major operating system update will take. The underlying statistical model embedded in the computer program can optionally be used to refine the predicted length of time left until the operating system installation or major update is complete. The estimate of time needed for the operating system installation or update is displayed to the installer. A periodic or continual display of the amount of time left until predicted completion can be provided based on counting down the predicted operating system install/update time duration.

Additional features and advantages may be realized through the method and system of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic diagram of a computer system with the key components involved in the process of providing a reliable estimate of the time remaining during the process of installing a new operating system or making a major update to it; and

FIG. 2 is a flow chart of a preferred method for providing a reliable estimate of the length of the install time and of the remaining time left until the operating system installation or update is complete.

For purposes of clarity and brevity, like elements and components will bear the same designations and numbering throughout the Figures.

### DESCRIPTION OF THE PREFERRED EMBODIMENT

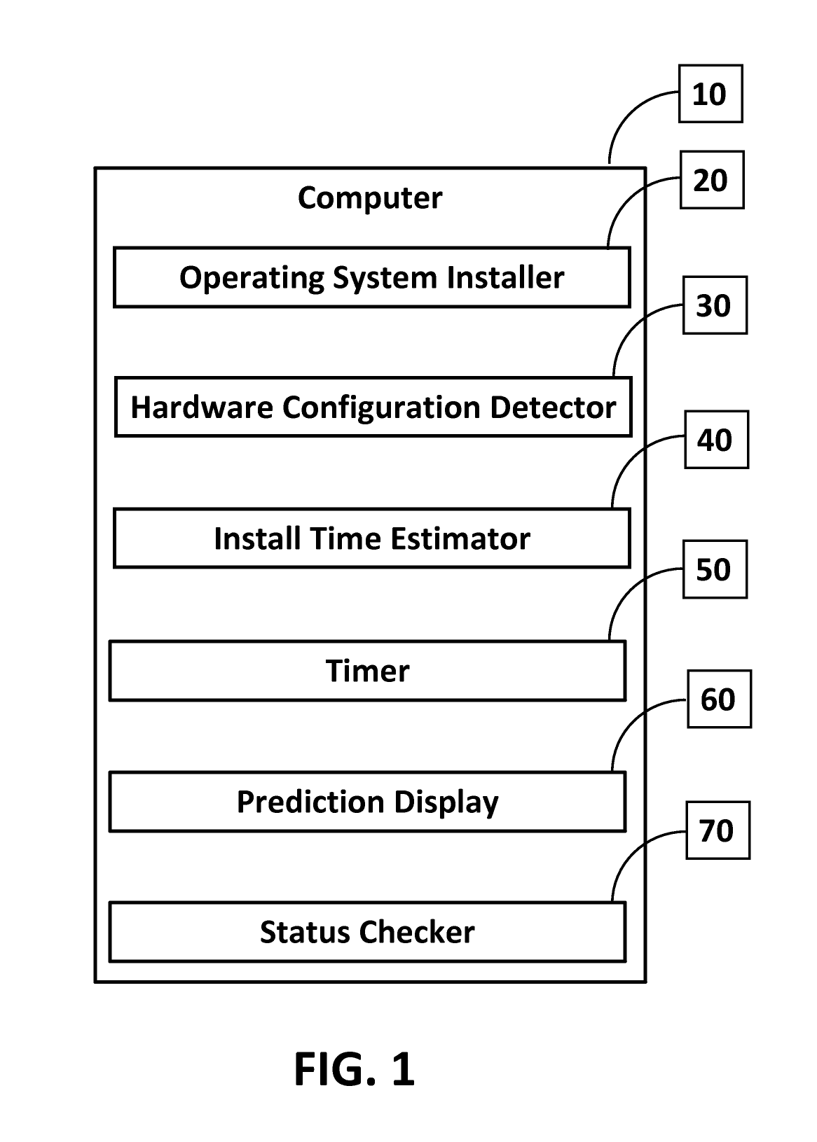

FIG. 1 is a schematic diagram of a computer 10 system, defined here as containing hardware components, including but not limited to, a processor and accessible memory, with the key modules involved in the process of providing reliable estimates of the time remaining during the process of installing a new operating system or making a major update to that operating system. The process takes place within a computer 10. It is started by an operating system installer 20 whose task is to either install a new operating system on the computer 10 or to install a major update to an existing operating system on the computer 10. The computer 10 can be any computing device with an operating system. The operating system installer 20 invokes the hardware configuration detector 30. This detector determines the key components of the computing system 10. The install time estimator 40 takes information from the hardware configuration detector 30 and provides a statistically based prediction of the length of time the operating system installer 20 will take until it completes its task. A timer 50 is started and the length of time is counted down until the time the operating system installer 20 is predicted to complete its task is reached or the status checker 70 indicates the installation is complete. The predicted install time length from the install time estimator 40 is provided to the prediction display 60. The prediction display 60 can also display periodically or continually the predicted length of time left until the operating system installer 20 completes its task from the install time estimator 40 by counting down from the timer 50 set with this time duration. The status checker 70 checks at one or more places in the operating system install process and provides relevant information to the install time estimator 40.

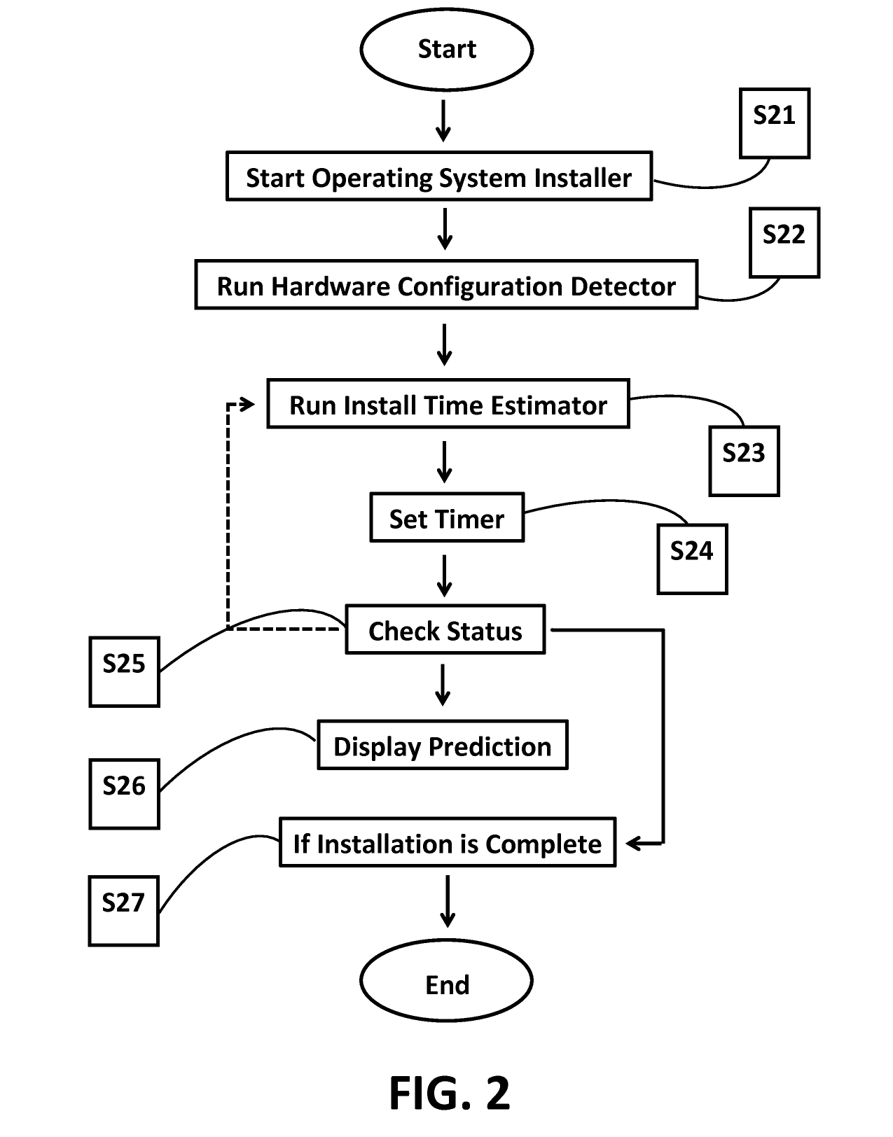

FIG. 2 is a flow chart of a preferred method for providing a reliable estimate of the length of the install time that utilizes the system of FIG. 1. In step S21, the operating system installer 20, which either installs a new operating system on a computer 10 or a major update of an existing operating system on a computer 10 is run. At the beginning of step S21, the operating system installer 20 starts the hardware configuration detector 30. In step S22, the hardware configuration detector 30 determines the relevant information about the hardware components of the computer 10 and passes that information to the install time estimator 40. In step S23, the install time estimator 40 provides a prediction for how long the operating system installation or update will take. In step S24, the install time estimator 40 starts a timer 50 that keeps track of how much time has elapsed since it was started. In step S25, the status of the operating system installer 20 is checked by the status checker 70 and, if requested, this information is passed to the install time estimator 40 which may then update the length of time the rest of the operating system installation is predicted to take (in which case the process invokes step S24 again). In step S26, the install time prediction from the install time estimator 40 is displayed by the prediction display 60. In step S26, the prediction display 60 can also show the length of time remaining until the operating system installation or updating is completed (which is the predicted install time minus the elapsed time obtained from the timer 50). In step S27, when the appropriate report is received from the status checker that the operating system installer 20 has completed, then the prediction display 60 will report that the operating system installation or update is complete.

The implementation of the process can better be illustrated by the following example. A new operating system is to be installed on a computer 10. The process is embedded in the operating system installer 20 as a software program. When the operating system installer 20 starts, the hardware configuration detector 30 determines what hardware components make up the system and passes that information on to the install time estimator 40. Based on that information, the install time estimator 40 provides an estimate of how long the operating system will take to install. This information is used to start a timer 50 that counts down the length of time provided to it by the install time estimator 40. The predicted install time is displayed by the prediction display 60 which will then, typically by using the information from the timer 50, display either continually or periodically, how much time remains until the operating system installation is complete. As the operating system reaches key check points in the installation process, it sends this information to the status checker 70. The install time estimator 40 provides the status checker 70 with a list of check points that it wants to be informed of including the completion of the installation process. The install time estimator 40 may optionally use the length of time obtained from the timer 50 it took the operating system to reach a particular check point to update the predicted install time. When this is done, the timer 50 is reset with the new prediction of the length of time until the operating system installer 20 has completed its task. The prediction display 60 is also updated to display this information in some form. Typically, this information will take the form of the predicted length of time needed for the operating system installation to be completed or in the form of a continual or periodic display of this prediction minus the length of elapsed time from the timer 50. When the status checker 70 indicates the key check point of the operating system installer 20 having completed its task, this information is sent to the install time estimator 40 which resets the timer 50 to a time of zero. This is indicated on the prediction display 60. The install time estimator 40 then stops the process.

In many embodiments of the invention, some of the components in FIG. 1 will likely be provided by the operating system installer 20 or the operating system itself. These components will often need only relatively small modifications for use by the process. An operating system installer 20 already invokes different hardware and software processes. The invention in many embodiments will simply be one more process started by the operating system installer 20. An operating system installer 20 will often detect what hardware components are contained in the computer 10 by accessing the computer's 10 BIOS or firmware. This determines whether the operating system embodied in the operating system installer 20 is appropriate for the computer's hardware configuration. It can also influence how the operating system is installed on the computer 10. Operating systems often contain a software based timer 50 that can access an internal clock in the computer 10. The operating system installer 20 often performs a set of tasks in installing the operating system. When these tasks are completed they can be, and often are, recorded by the operating system installer 20 or the operating system. The recording of this information comprises part of the status checker 70. Operating systems sometimes contain ways to display information about time to users and there are many approaches to displaying time related information in current use.

The install time estimator 40 plays a major role in the process providing a reliable prediction of the length of time it will take the operating system installer 20 to install a new operating system or perform a major update to the operating system. The install time estimator 40 can be implemented in several ways that base the install time prediction on statistical information. The simplest and generally most accurate approach, A, is applicable when there is only one or a reasonably small number of configurations for the hardware components of the computer 10. In this case, the operating system installer 20 can be run multiple times on a computer 10 with a particular hardware configuration by the operating system developer and the length of time the operating system installer 20 took to complete its task recorded. This data on the length of time the operating system installer 20 took to complete its task can be statistically analyzed and summary statistics computed. One of these statistics, such as median install time, can be taken as the prediction of the length of time it takes the operating system installer 20 to complete its task. Given that hardware configuration, this install time prediction can then be used in the install time estimator 40 which is distributed with the operating system installer 20 to computer users. If the mean and median install operating system install times are reasonable and the variability in install times on a particular computer 10 hardware configuration sufficiently small, there will be no need for the install time estimator 40 to take any other actions other than activating the timer 50 and counting down the length of time until the operating system installer 20 is predicted to complete its task. This process comes to an end when the status checker 70 indicates that the operating system installation or major update is complete. This approach illustrates a key aspect of the proposed invention. If for a specific hardware configuration, as verified by the hardware configuration detector 30, the length of time that an operating system installer 20 is likely to take to complete its task can be determined before the operating system installer 20 is distributed to computer 10 users and there is relatively little uncertainty about how long it will take to complete, then the prediction of install time length can be provided to the install time estimator 40 at the same time the operating system installer 20 is created. This prediction will provide users with a reliable estimate of install time length. To further illustrate the advantage of the proposed invention, in an application to one of the most popular computer operating systems, Microsoft Windows XP™, the operating system installer 20 across twenty-seven different hardware configurations considered has an average absolute forecast error of thirteen minutes with respect to how long the computer 10 user is informed the operating system installer 20 will take and how long it actually takes. Using the approach described here results in an absolute average forecast error of less than one minute.

When the variability in the length of time the operating system installer 20 takes to complete its task is large enough to be of concern to computer 10 users, it may be desirable to use approach B. This approach modifies approach A by allowing for the install time estimator 40 to update its prediction of the length of time it will take the operating system to complete its task at one or more major check points as reported by the status checker 70 as the operating system installer 20 proceeds in completing its task. Under approach B, the initial install time prediction is the same described immediately above for approach A; however, when the status checker 70 reports to the install time estimator 40 that a check point has been reached, then the install time estimator will produce a new prediction of how much longer the operating system installer 20 will take until it completes its task. When this happens, the timer 50 will be reset and the new information on how much longer the operating system installer 20 is expected to take before its task is completed will be reflected in the prediction display 60. This new prediction of the remaining length of time until the operating system installer 20 has completed its tasks can also be based on data obtained from multiple trials of the operating system installer 20 on a particular hardware configuration. In this case, the new prediction will be based on a statistical model that takes into account the same statistical information as the approach above plus the extra statistical information contained in how long it took the operating system installer 20 to reach a particular check point as reported by the status checker 70. The statistical model is developed from the data on repeated runs of the operating system installer 20 on a particular computer 10 hardware configuration.

Both of the two approaches above are easily extended to multiple computer 10 hardware configurations as long as each of the relevant hardware configurations has been individually tested. In this case, the same operating system installer 20 is used for multiple hardware configurations and the hardware configuration detector 30 plays a more substantive role by distinguishing between different computer 10 hardware configurations. After identifying a particular computer 10 hardware configuration using the hardware configuration detector 30, this information is passed to the install time estimator 40 which selects either a specific install time prediction based on previously developed statistical information under approach A or an initial install time prediction and a statistical model for updating that prediction using information from the timer 50 and the status checker 70.

There may be instances where all possible hardware configurations of a computer 10 that the operating system installer 20 may be used on that have not been the subject of repeated application of the operating system installer 20, but where the hardware configuration detector 30 is able to identify the hardware components of the computer 10 that will substantially determine how long it takes the operating system installer 20 to complete its task. In this case, repeated application of the operating system installer 20 to a range of different hardware configurations by the operating system developer can be used to develop a statistical model using parametric or non-parametric techniques that provides a reliable prediction of how long the operating system installer 20 will take to complete its task. Under this approach C, this statistical model can be used by the install time estimator 40 in conjunction with information provided by the hardware configuration detector 30 to derive a prediction of the length of time it will take the operating system installer 20 to complete its task, which can then be used in a manner similar to the install time prediction under approach A. It is also possible to revise this initial prediction in a manner similar to approach B if the variability of install time predictions given the hardware components in the computer 10 detected by the hardware configuration detector 30 is found to be large enough that computer 10 users may find a revised prediction of the length of time needed for the operating system installer 20 to complete its tasks after passing one or more check points, as determined by the status checker 70, useful. As a specific example, a personal computer 10 with a processor of a certain speed, with a specific quantity of random access memory, and a hard drive of a particular speed can be predicted to install a particular operating system in a specific amount of time using a relevant statistical model if that model is constructed using data from repeated application of an operating system installer 20 to different computer 10 hardware configurations that vary by processor speed, random access memory size, and hard drive speed. In the aforementioned application to computer 10 Microsoft Windows XP™, using the approach C described here results in an absolute average forecast error of less than two minutes.

There may be instances where there are relevant hardware components in the computer 10 that are identified by the hardware configuration detector 30 whose influence on the length of time the operating system installer 20 will take to complete its task are unknown because those components have not been the subject of prior performance testing by the operating system developer. The performance characteristics of these components can usually be determined to a reasonable degree of accuracy for the purpose intended here by having the install time estimator 40 run short performance tests on those components. Such tests are usually already developed and sometimes available in an operating system installer 20. Under this approach D, the parametric or non-parametric statistical model built using data from repeated runs of the operating system installer 20 on different hardware configurations where the performance characteristics of the hardware components identified by the hardware configuration detector 30 are determined by running short performance tests. This statistical model is then used by the install time estimator 40 in conjunction with short performance tests run on the relevant hardware components determined to be present by the hardware component detector 30 in the particular computer 10 that the operating system installer 20 is being run on. This approach is similar to approach C, except that the statistical model used by the install time estimator 40 is based on the hardware component performance tests rather than identification of the characteristics of the actual hardware. As under approach C, it is possible to revise the original predicted length of time it takes the operating system installer 20 to finish its task based on the length of time the status checker 70 determines it took to reach one or more check points in the operating system install process.

Under approaches A and B, the hardware configuration of the computer 10 has been the subject of repeated runs of the operating system installer 20 so that it is possible to use a fairly simple statistical approach to determine a reliable prediction of the length of time the operating system installer 20 will complete its task. Whether it is desirable to use the more complicated approach B, involving one or more revisions of the remaining time left until the operating system installer 20 has completed its task, rather than approach A, will depend on how variable the length of time the operating system installer 20 takes to complete its task is, and how much reduction there is in the estimate of the remaining time left by using the information on how long it took the operating system to reach one or more check points identified by the status checker 70. With modern computer 10 hardware, approach A will often be sufficient.

Approaches C and D, are needed when comprehensive testing of all of the relevant hardware configurations for the operating system installer 20 have not been the subject of repeated timing tests with the operating system installer 20. In this case, it is possible to construct a statistical model using either information from the hardware configuration detector 30 about the nature of the hardware components or short performance tests of the hardware components. In many instances, the key characteristics of the hardware components are easily identified and have considerable predictive power with respect to how long the operating system installer 20 will take to complete its task and approach C will be adequate. For example, the brand and speed of a processor are usually quickly identified through a procedural inquiry of the operating system installer 20 to computer 10 BIOS or firmware. Approach D is somewhat more difficult to implement because it relies on short tests to determine hardware component performance characteristics and must perform those tests on the user's computer 10. It is a more generally applicable approach than C and applicable to a wider range of hardware components including those that were not in existence at the time the operating system installer 20 was created. It may also be desirable to use in instances where approach C is possible but there is considerable variation among the performance of hardware components that are recorded in the same way under approach C. For instance, under approach C, the amount of random access memory is reported by the hardware configuration detector 30 but the speed of the random access memory also has an influence on the length of time the operating system installer 20 takes to complete its task. This information is not reported by the hardware configuration detector 30 but could be determined by conducting a short performance test on the random access memory.

Another approach that could be used to develop a statistical model for use by the install time estimator 40 in providing a prediction of the length of time it is likely to take for the operating system installer 20 to complete its tasks is to run one or more short tests that are reflective of the types of operations that must be performed during the installation or updating of a computer 10 operating system. A statistical model could then be built using information from these tests to predict the length of time the operating system installer 20 will take to complete its task. These test(s) would then also be run by the install time estimator 40 and used as the basis for making a prediction of how long it will take the operating system installer 20 to complete its task in a manner similar to the hardware component tests under approach D.

The distributor of an operating system installer 20 may optionally, based on their beliefs about user preferences, set the install time estimator 40 to make either optimistic or conservative estimates, which, for example, may be the median install time for a hardware configuration plus or minus one standard deviation.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. A computer operating system install time predictor for providing a method and system for reliably estimating the length of time likely to be required for the installation or updating of an operating system on a computer, comprising:
means for determining what hardware components make up the computing system;
means for providing a method for statistically estimating the length of time it will likely take to install or update an operating system;
means for determining the length of time left until the predicted completion of the operating system installation or update;
means for displaying the length of time the operating system installer is predicted to take until complete and/or the predicted amount of time left until the operating system installer completes its task; and
means for determining where in the installation/updating process the operating system installer is.

2. The computer operating system install time predictor in accordance with claim 1, wherein said means for determining what hardware components make up the computing system comprises a hardware configuration detector.

3. The computer operating system install time predictor in accordance with claim 1, wherein said means for providing a method for statistically estimating the length of time it will likely take to install or update an operating system comprises an install time estimator.

4. The computer operating system install time predictor in accordance with claim 1, wherein said means for determining the length of time left until the predicted completion of the operating system installation or update comprises a timer.

5. The computer operating system install time predictor in accordance with claim 1, wherein said means for displaying the length of time the operating system installer is predicted to take until complete and/or the predicted amount of time left until the operating system installer completes its task comprises a prediction display.

6. The computer operating system install time predictor in accordance with claim 1, wherein said means for determining where in the installation/updating process the operating system installer is comprises a status checker.

7. A computer operating system install time predictor for providing a method and system for reliably estimating the length of time likely to be required for the installation or updating of an operating system on a computer, comprising:
a hardware configuration detector, for determining what hardware components make up the computing system;
an install time estimator, for providing a method for statistically estimating the length of time it will likely take to install or update an operating system;
a timer, for determining the length of time left until the predicted completion of the operating system installation or update;
a prediction display, for displaying the length of time the operating system installer is predicted to take until complete and/or the predicted amount of time left until the operating system installer completes its task; and
a status checker, for determining where in the installation/updating process the operating system installer is.
